(19) United States
(12) Patent Application Publication
(10) Pub. No.: US 2007/0217850 A1
(43) Pub. Date: Sep. 20, 2007

(54) INK SHEET CARTRIDGE

(75) Inventor: Takashi Nakai, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/686,936

(22) Filed: Mar. 15, 2007

(30) Foreign Application Priority Data
Mar. 17, 2006 (JP) 2006-074005
Mar. 17, 2006 (JP) 2006-074006

(51) Int. Cl. B41J 17/32

(52) U.S. Cl. 400/208

(57) ABSTRACT

In an ink sheet cartridge, an ink sheet unit includes a first bobbin on which a longitudinal ink sheet is wound from one end thereof and a second bobbin on which the ink sheet is wound from the other end thereof, which are detachably received in a cartridge case. The cartridge case includes: a case body having an opening portion formed at the center thereof so as to expose the ink sheet used for a printing operation of a printer; a driving-side sidewall portion disposed vertically on one side of the case body so as to rotatably support driving-side shaft portions formed on ends of the first bobbin and the second bobbin; and a supporting-side sidewall portion disposed on the other side of the case body so as to rotatably support supporting-side shaft portions formed on the other ends of the first bobbin and the second bobbin.

This application claims the benefit of priority under 35 U.S.C. §119 to Japanese Patent Application Nos. 2006-074005 and 2006-074006 both filed Mar. 17, 2006, and are hereby incorporated by reference in its entirety.

### BACKGROUND

1. Field of the Invention

The present invention relates to an ink sheet cartridge, and more particularly, to an ink sheet cartridge used in a line thermal printer for printing a print image.

2. Description of the Related Art

In general, a line thermal printer having a longitudinal thermal head of which heater elements are arranged in a width direction of a printing paper is used as a printer which promptly performs a printing operation line by line or page-by-page on a printing paper.

As an ink sheet cartridge for the line thermal printer, an ink sheet cartridge has been used which receives an ink sheet unit in a cartridge case. In the cartridge case, the ink sheet unit is formed such that one end of a longitudinal ink sheet has a coloring region that is applied with ink of yellow, magenta, cyan, or the like colors, and is continuously wound around a sheet supply bobbin of a cylindrical shape while the other end of the ink sheet is wound around a winding bobbin of a cylindrical shape.

In the ink sheet cartridge used in the past, the cartridge case includes upper and lower halves made of a synthetic resin, which are bonded or engaged with each other by an ultrasonic welding or a snap in method that receives the ink sheet unit to rotatably and pivotally support the sheet supply and winding bobbins.

However, in the ink sheet cartridge having the cartridge case formed by bonding the upper and lower halves with each other, it is difficult to reuse the cartridge case, since the cartridge case needs to be inevitably broken to replace a used ink sheet unit with an unused ink sheet unit. Likewise, in the ink sheet cartridge having the cartridge case formed by engaging the upper and lower halves with each other in terms of the snap-in method, it is difficult for a common user to reuse the cartridge case and to only replace the ink sheet unit, since a tool or a certain degree of skill is necessary to detach the halves engaged by the snap-in method.

### SUMMARY OF THE DISCLOSURE

At least one object of the present disclosure is to provide an ink sheet cartridge of which an ink sheet set can be easily replaced, and an effective utilization of resources can be achieved because a reuse of the cartridge case is possible.

In order to achieve the above object, according to a first aspect of an ink sheet cartridge, there is provided the ink sheet cartridge in which an ink sheet unit includes a first bobbin on which a longitudinal ink sheet is wound from one end thereof and a second bobbin on which the ink sheet is wound from the other end thereof, which are detachably received in a cartridge case. The cartridge case includes: a case body having an opening portion formed at the center thereof so as to expose the ink sheet used for a printing operation of a printer; a driving-side sidewall portion disposed vertically on one side of the case body so as to rotatably and pivotally support driving-side shaft portions formed on ends of the first bobbin and the second bobbin; and a supporting-side sidewall portion disposed on the other side of the case body so as to rotatably and pivotally support supporting-side shaft portions formed on the other ends of the first bobbin and the second bobbin.

The ink sheet cartridge is formed in a semi-open type structure so as to receive and hold the ink sheet unit in a space formed by the case body, the driving-side sidewall portion, and the supporting-side sidewall portion. Thus, the ink sheet cartridge does not need labor or skill to disassemble the cartridge case and the ink sheet unit can be easily replaced, thereby easily reusing the cartridge case.

According to a second aspect of an ink sheet cartridge, there is provided the ink sheet cartridge in which the supporting-side sidewall portion includes an outer wall portion forming an outer wall of the cartridge case, an inner wall portion disposed vertically in parallel to the outer wall portion with a predetermined gap therebetween and having a bearing portion so as to support pivotally one end of the first bobbin and/or the second bobbin, and a central wall portion disposed vertically in the gap between the outer wall portion and the inner wall portion, abutting one end of the first bobbin and/or the second bobbin on an inner wall surface, and allowing the first bobbin and/or the second bobbin to be biased toward the driving-side sidewall portion.

In the ink sheet cartridge, since the one end of the first bobbin and/or the second bobbin is abutted on the inner wall surface of the central wall portion and the first bobbin and/or the second bobbin is biased toward the driving-side sidewall portion, the flange on the other side is brought into contact with the sidewall of the cartridge case. Therefore, an idle rotation of the first bobbin and/or the second bobbin is prevented when the cartridge case is not fitted into the printer, thereby preventing the looseness of the ink sheet.

Further, according to a third aspect of the ink sheet cartridge, the central wall portion is a cantilever-shaped plate member of which a base portion is fixed to the cartridge case.

The ink sheet cartridge of the disclosure pivotally supports the one end of the first bobbin and/or the second bobbin by a bearing portion while bending an end of the central wall portion toward the outer wall portion of the supporting-side. Then, by returning the end of the central wall portion to an original position, the one end of the first bobbin and/or the second bobbin can be abutted on the inner wall surface.

According to a fourth aspect, there is provided an ink sheet cartridge in which a spring member is formed on the driving-side sidewall portion so as to bias the first bobbin and/or the second bobbin toward the driving-side sidewall portion, wherein a locking portion is formed on the inner wall surface of the outer wall portion so as to lock one end of the spring member, a locking portion is formed on the outer wall surface of the central wall portion so as to lock the other end of the spring member, and a protrusion is formed on the inner wall surface of the central wall portion so as to abut against one end of the first bobbin and/or the second bobbin and to restrict a position of the first bobbin and/or the second bobbin to the inside of the bearing portion.

In the ink sheet cartridge of the disclosure, since the central wall portion is pressed toward the bobbin with an elasticity restoring force of the spring member to indirectly bias the first bobbin and/or the second bobbin toward the driving-side sidewall portion, the flange on the other side is brought into contact with the sidewall of the cartridge case. Therefore, the idle rotation of the first bobbin and/or the second bobbin is prevented when the cartridge case is not fitted into the printer, thereby preventing the looseness of the ink sheet. In addition, by disposing the spring member to help the central wall portion to bias the first bobbin and/or the second bobbin toward the driving-side sidewall portion, a durability of the central wall portion which is a flexible member can be increased, thereby increasing a durability of the cartridge case itself.

In addition, a guiding protrusion formed on the surface opposed to the central wall portion is locked to an end of the supporting-side shaft portion and a position of the supporting-side shaft portion is restricted to the inside of the bearing portion, thereby preventing the supporting-side shaft portion of the first bobbin and/or the second bobbin from separating from the bearing portion.

According to a fifth aspect, there is provided the ink sheet cartridge in which a protrusion extending in a space portion right above the spring member is provided.

In the ink sheet cartridge, even when the locking of the spring member between the locking portion formed on the outer wall portion and the locking portion formed on the driving wall portion is unlocked with a certain shock at the time of detaching the first bobbin and/or the second bobbin from the cartridge case for the purpose of replacing the ink sheet unit, for instance, it is possible to prevent the spring member from protruding toward an open space of the ink sheet cartridge by the use of the protrusion. Accordingly, safety of a user can be obtained and loss of the spring member can be prevented.

As described above, according to an ink sheet cartridge of the disclosure, because the cartridge case is formed in a semi-open type structure so as to receive the ink sheet, labor and skill required to disassemble an upper half of previously used cartridge cases are not necessary. Therefore, the ink sheet can be safely and easily replaced and the cartridge case can be reused.

In addition, since a thickness of the ink sheet cartridge is restricted, a significant effect which contributes to a decrease in size of the printer having the ink sheet cartridge can be achieved.

### BRIEF DESCRIPTION OF THE DRAWINGS

FIG. 1 is a plan view illustrating a main part of an ink sheet cartridge according to an embodiment of the present disclosure.

FIG. 2 is a perspective view illustrating a first bobbin and a second bobbin of an ink sheet cartridge according to an embodiment of the present disclosure.

FIG. 3 is a perspective view illustrating a main part of a driving-side sidewall portion of a cartridge case of an ink sheet cartridge according to an embodiment of the present disclosure.

FIG. 4 is a plan view illustrating a main part of the supporting-side sidewall portion of a cartridge case of an ink sheet cartridge according to the embodiment of the present disclosure.

FIG. 5 is a sectional view illustrating a main part of the supporting-side sidewall portion of a cartridge case of an ink sheet cartridge according to an embodiment of the present disclosure.

FIG. 6 is an exemplary view illustrating an ink sheet cartridge fitted into a printer according to an embodiment of the present disclosure.

### DESCRIPTION OF THE PREFERRED EMBODIMENTS

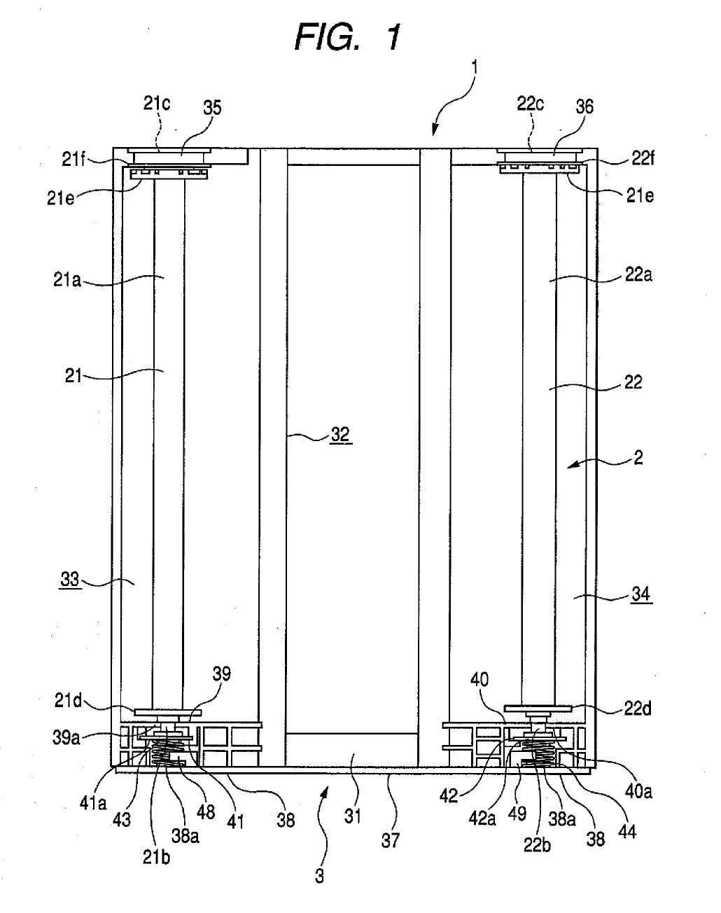

Hereinafter, an ink sheet cartridge according to embodiments of the disclosure will be described with reference to FIGS. 1 through 6.

As shown in FIG. 1, an ink sheet cartridge 1 according to an embodiment includes an ink sheet unit 2 and a cartridge case 3 receiving the ink sheet unit 2.

The ink sheet unit 2 includes a longitudinal ink sheet (not shown) of which a coloring region is continuously applied with ink of yellow (Y), magenta (M), and cyan (C) a first bobbin 21 on which the ink sheet is wound from one end thereof, and a second bobbin 22 on which the ink sheet is wound from the other end thereof.

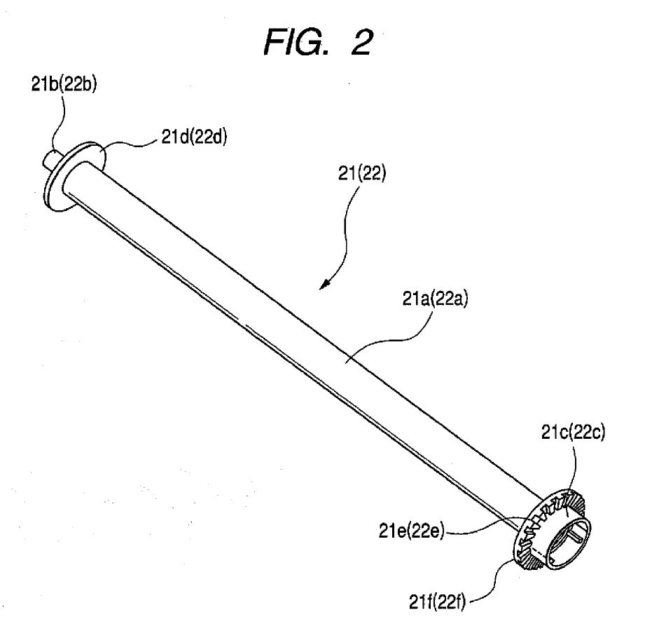

As shown in FIGS. 1 and 2, the first and second bobbins 21 and 22 are made of resin cylindrical members with substantially the same size and include shaft bodies 21a and 22a disposed at the center thereof. Also included are supporting-side shaft portions 21b and 22b formed on the one end of the shaft bodies 21a and 22a with a diameter smaller than an outer diameter of the shaft bodies 21a and 22a, and driving-side shaft portions 21c and 22c formed on the other end from the shaft bodies 21a and 22a having a diameter larger than the outer diameter of the shaft bodies 21a and 22a.

A driving system of the printer (not shown) that transmits a driving force for rotating the first and second bobbins 21 and 22 contacts the driving-side shaft portions 21c and 22c. The supporting-side shaft portions 21b and 22b and the driving-side shaft portions 21c and 22c include guard-shaped flanges formed at a boundary with the shaft bodies 21a and 22a, respectively (e.g., flanges 21d and 22d of the supporting-side shaft portions 21b and 22b, and flanges 21e and 22e of the driving-side shaft portions 21c and 22c). In addition, rectangular grooves 21f and 22f of a plurality of rectangular shapes are used as a fitting portion, being formed on the outer wall surface of the flanges 21e and 22e disposed on the driving-side shaft portions 21c and 22c, and radially arranged thereabout.

One end of an unused ink sheet is wound on the shaft body 21a of the first bobbin 21 and the other end of the ink sheet is wound on the shaft body 22a of the second bobbin 22.

The cartridge case 3 includes one case body 31 on which an opening portion 32 is formed at the center thereof so as to abut a printing portion (not shown) of the printer on the ink sheet tensely stretched between the first and second bobbins 21 and 22.

In one embodiment, the case body 31 is an approximately plate-shaped member made of resin and includes the opening portion 32 of a window frame shape at the center thereof. Both ends of the case body 31 are formed in a bent semi-cylindrical shape, wherein one end of the case body includes a first bobbin-side dome portion 33 so as to receive the wound ink sheet and the first bobbin 21, and the other end of the case body includes a second bobbin-side dome portion 34 so as to receive the wound ink sheet and the second bobbin 22.

On both ends of the case body 31, driving-side sidewall portions 35 and 36 which rotatably support the driving-side shaft portions 21c and 22c are formed on respective ends of the first and second bobbins 21 and 22 and are disposed vertically. A supporting-side sidewall portion 37 which rotatably supports the driving-side shaft portions 21d and 22d formed on each of the ends of the first and second bobbins 21 and 22 and is vertically disposed.

More specifically, the driving-side sidewall portions 35 and 36 are formed on one end of the case body 31 where the driving-side sidewall portion 35 has an approximately circular shape and is disposed vertically to correspond to the first bobbin-side dome portion 33, and the driving-side sidewall portion 36 has an approximately circular shape and is disposed vertically to correspond to the second bobbin-side dame portion 34.

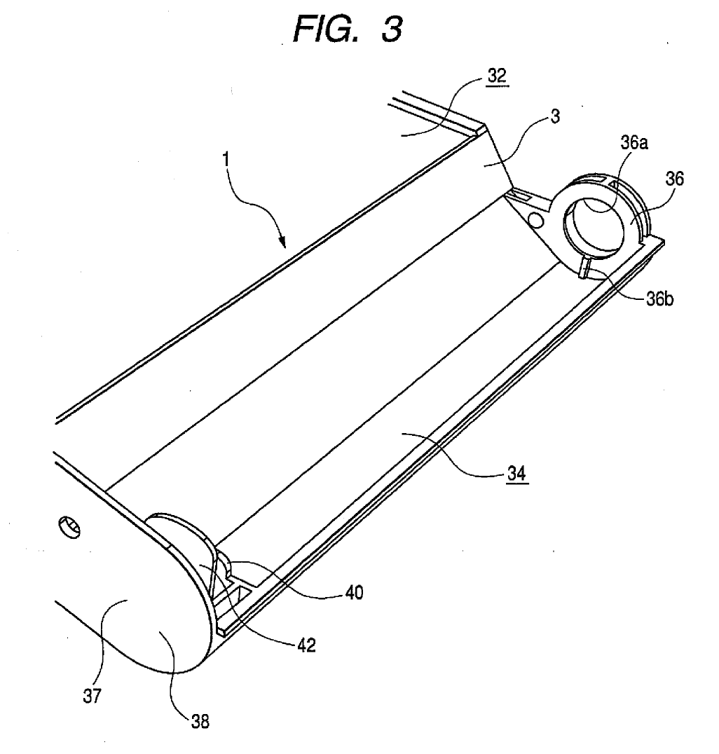

In one embodiment, since the driving-side sidewall portion 35 has an approximately circular shape and is disposed vertically to correspond to the first bobbin-side dame portion 33 and the driving-side sidewall portion 36 that also have the approximately circular shape and are disposed vertically to correspond to the second bobbin-side dame portion 34, a structure of only the driving-side sidewall portion 36 of the second bobbin-side dome portion 34 will be described in detail with reference to FIG. 3. A bracketed reference numeral is a reference numeral of the corresponding member of the first bobbin-side dome portion 33.

On the central part of the wall surface of the driving-side sidewall portion 36 (35), a hole shaped bearing portion 36a (35a) is formed to rotatably support the driving-side shaft portion 22c (21c) of the second bobbin 22 (21). On the inner wall surface of the driving-side sidewall portion 36 (35), an engagement protrusion 36b extends in a diameter direction of the hole-shaped bearing portion 36a (35a) and is inserted in the rectangular groove 22f (21f) formed on the outer wall surface of the flange 22e (21e) of the driving-side shaft portion 22c (21c).

In one embodiment, the supporting-side sidewall portion 37 includes one outer wall portion 38 forming the outer wall of the cartridge case 3, inner wall portions 39 and 40 disposed vertically in parallel to the outer wall portion 38 with a predetermined gap in the first bobbin-side dome portion 33 and the second bobbin-side dome portion 34 of the cartridge case 3. The supporting-side sidewall portion 37 further includes central wall portions 41 and 42 disposed vertically in parallel to the outer wall portion 38 with the gap between the outer wall portion 38 and the inner wall portions 39 and 40 in the first bobbin-side dome portion 33 and the second bobbin-side dome portion 34 of the cartridge case 3.

Additionally, between the outer wall portion 38 and the central wall portions 41 and 42, spring members 43 and 44 having a coil shape are formed to press the central wall portions 41 and 42 toward the first and second bobbins 21 and 22 by an elastic restoring force so as to indirectly bias the first and second bobbins 21 and 22 in a direction of the driving-side sidewall portions 35 and 36, respectively.

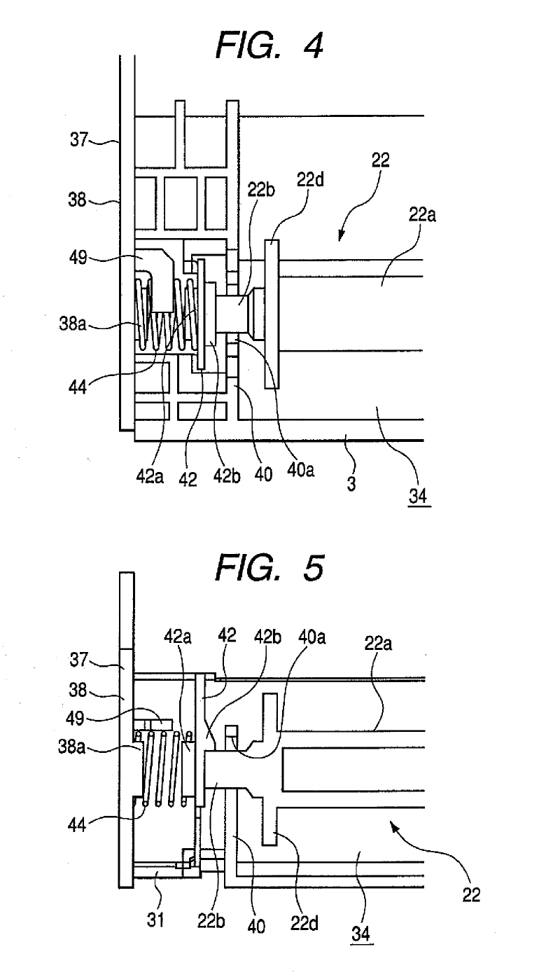

In one embodiment, since the supporting-side sidewall portion 37 is formed on the first bobbin-side dome portion 33 and the second bobbin-side dome portion 34 in the same manner, a structure of only the supporting-side sidewall portion 37 of the second bobbin-side dame portion 34 will be described in detail with reference to FIGS. 4 and 5. A bracketed reference numeral is a reference numeral of the corresponding member of the first bobbin-side dome portion 33.

On the inner wall portion 40 (39) of the supporting-side sidewall portion 37, a U-shaped bearing portion 40a (39a) is opened on an edge of the inner wall portion 40 (39) to insert the supporting-side shaft portion 22b (21b) of the second bobbin 22 (21) therein.

Additionally, a convex-shaped locking portion 38a is formed on the inner wall surface of the outer wall portion 38 so as to lock one end of the spring member 44 (43), and a convex shaped locking portion 42a (41a) is formed on the outer wall surface of the central wall portion 42 (41) so as to lock the other end of the spring member 44 (43). That is, the spring member 44 (43) is disposed between the outer wall portion 38 and the central wall portion 42 (41) by locking both ends thereof in the locking portions 38a and 42a (38a and 41a).

The central wall portion 42 (41) is a plate-shaped member of which a base portion is fixed on the case body 31, and is formed in a cantilever-shape which allows its edge to be flexible in a direction perpendicular to the outer wall portion. In addition, while releasing the flexibility, the supporting-side shaft portion 22b (21b) of the second bobbin 22 (21) abuts on the inner wall surface, thereby biasing the second bobbin 22 (21) toward the driving-side sidewall portion 36 (35).

In addition, on the inner wall surface of the central wall portion 42 (41), a guiding wall surface is formed in a slope rising from the edge of the central wall portion 42 (41) to the base portion and a guiding protrusion 42b (41b) is formed to include a locking surface extending perpendicular to the inner wall surface of the central wall portion 42 (41) and that is parallel to the inner wall surface of the case body 31. Also, the edge of the central wall portion 42 (41) is formed as a gripper portion which enables a user to manipulate the central wall portion 42 (41).

In addition, in one embodiment, on the supporting-side sidewall portion 37, a protrusion 49 (48) having an approximately flat L-shape of which an end thereof is connected to the inner wall surface of the outer wall portion 38 is covered. More specifically, the protrusion 49 (48) extends in parallel to the case body 31 in a space portion right above the spring member 44 (43) between the outer wall portion 38 and a position at which the central wall portion 42 (41) is allowed to be closest to the outer wall portion 38 against the pressing force of the spring member 44 (43).

Hereinafter, an example of a method of attaching and detaching the ink sheet unit 2 from the cartridge case 3 will be described.

When an unused ink sheet unit 2 is inserted into the cartridge case 3, the inside of the cartridge case 3 faces the upside down. The first bobbin 21 of the ink sheet unit 2 is received in the space portion having a sectional semicircular shape (hereinafter referred to as a first bobbin receiving portion) formed by the driving-side sidewall portion 35, the supporting-side sidewall portion 37, and the first bobbin-side dome portion 33.

First, the driving-side shaft portion 21c of the first bobbin 21 is inserted into the hole-shaped bearing portion 35a formed on the driving-side sidewall portion 35 so as to rotatably abut therein. At this time, the rectangular groove 21f formed on the inner wall surface of the flange 21e is engaged with the engagement protrusion 35b formed on the driving-side sidewall portion 35. By engaging the engagement protrusion 35b and the rectangular groove 21f, a looseness of the ink sheet generated at the time of not using the sheet can be prevented, whereby deterioration of a quality of the sheet caused by the rubbing of the ink sheet can be prevented.

Next, the edge of the supporting-side shaft portion 21b abuts on the guiding wall surface of the guiding protrusion 41b formed on the central wall 41 to slide thereon and the central wall portion 41 is bent toward the outer wall portion, thereby engaging the edge within the bearing portion 39a of the U-shape formed on the inner wall portion 39. At this time, the user enables the central wall portion 41 to be flexible toward the outer wall portion against the pressing force of the spring member 43 by gripping the gripper portion formed on the end thereof.

When the edge of the supporting-side shaft portion 22c departs the guiding wall surface of the guiding protrusion 41b and is inserted into the bearing portion 39a, the central wall portion 41 is pressed back to the inner wall portion with the flexibility restoring force thereof and the elasticity restoring force of the spring member 43. The first bobbin 21 is received in the first bobbin receiving portion by abutting the supporting-side shaft portion 22b of the first bobbin 21 on the inner wall surface and biasing the first bobbin 21 toward the driving-side sidewall portion 36 (35). Likewise, the flange 22e is brought into contact with the driving-side sidewall portion 35 of the cartridge case 3 by biasing the first bobbin 21 toward the driving-side sidewall portion, the rectangular groove 21f formed on the outer wall surface of the flange 21e is engaged with the engagement protrusion 35b formed on the driving-side sidewall portion 35, and thus an idle rotation of the first bobbin 21 is prevented when the cartridge case is not inserted into the printer, thereby preventing the looseness of the ink sheet.

Accordingly, when the first bobbin 21 is inserted into the receiving portion of the first bobbin 21, an unused ink sheet wound around the first bobbin 21 is tensely stretched to the opening portion 32 of the case body 31 which is opened as a transport path. Thus, the second bobbin 22 is received in the space portion having the sectional semi-circular shape (hereinafter, referred to as a second bobbin receiving portion) formed by the driving-side sidewall portion 36, the supporting-side sidewall portion 37, and the second bobbin-side dome portion 34. A receiving method thereof is the same as the receiving of the first bobbin 21 so that the description will be omitted.

Accordingly, the ink sheet cartridge 1 receiving the ink sheet unit 2 in the cartridge case 3 is fitted into a predetermined position of the printer and provided for a printing.

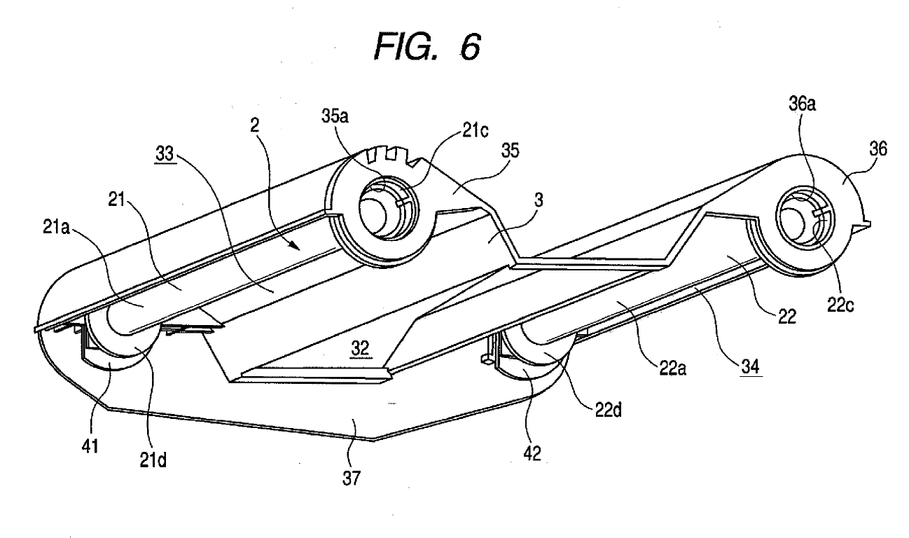

As shown in FIG. 6, in the ink sheet cartridge 1 of the embodiment, the outer wall surface of the case body 31 faces upside down at the time of inserting the cartridge into the printer. That is, the ink sheet cartridge 1 of the embodiment is formed in a semi-open type structure so as to receive and hold the ink sheet unit 2 in the upper half of the above-mentioned known ink sheet cartridge.

The ink sheet cartridge 1 of one embodiment having the semi-open type structure does not need labor or skill to disassemble the cartridge case 3, thereby easily replacing and recovering the ink sheet unit 2. Additionally, the cartridge case 3 can be reused, and thus a running cost is cheap as well.

Also, at the time of using the ink sheet cartridge 1, the locking surfaces of the guiding protrusions 41b and 42b formed on the central wall portions 41 and 42 lock the edges of the supporting-side shaft portions 21b and 22b of the first and second bobbins 21 and 22 and restrict the supporting-side shaft portions 21b and 22b to the inside of the bearing portions 39a and 40a, thereby preventing the supporting-side shaft portions 21b and 22b of the first and the second bobbins 21 and 22 from separating from the bearing portions 39a and 40a.

In addition, for recovering the used ink sheet unit 2 from the cartridge case 3, first, the inside of the cartridge case 3 is allowed to face upside down. Then, the second bobbin 22 on which the used ink sheet is wound is recovered from the bobbin receiving portion of the sheet winding-side.

At this time, the user enables the central wall portion 42 to flex toward the outer wall portion 38 against the pressing force of the spring member 44 while gripping the gripper portion formed on the end thereof. The user takes out the supporting-side shaft portion 22b frame the U-shaped bearing portion 40a of the inner wall portion 40 while releasing the engagement of the guiding protrusion 42b and the supporting-side shaft portion 22b, and continuously releases the insertion of the driving-side shaft portion 22c from within the bearing portion 36a formed on the driving-side sidewall portion 36.

Then, the first bobbin 21 winding of the used ink sheet is recovered from the bobbin receiving portion of the sheet winding-side as described above.

Furthermore, in the ink sheet cartridge 1 of one embodiment, when the spring members 43 and 44 are unlocked with a certain shock at the time of detaching the first and second bobbins 21 and 22 from the cartridge case 3, it is possible to prevent the spring members 43 and 44 from protruding from the ink sheet cartridge 1 by using the protrusions 48 and 49 that cause the spring members 43 and 44 to protrude toward the space portion right above the spring members 43 and 44. Thus, it is safe. Additionally, losing the spring members 43 and 44 can be prevented.

When the cartridge case 3 needs to be scraped because of prolonged usage of the ink sheet cartridge 1, the user can scrape the cartridge case 3 by sorting the metal spring members 43 and 44 and the resin cartridge case 3 after bending a connection part (not shown) between the protrusions 48 and 49 disposed in the space portion right above the spring members 43 and 44 and the outer wall portion 38. In addition, since the spring members 43 and 44 are provided to allow the central walls 41 and 42 to bias the first and second bobbins 21 and 22 toward the driving-side sidewall portions 35 and 36, contents of the central wall portions 41 and 42 which are flexible members can be increased. Therefore, the content of the reusable cartridge case 3 itself can be increased.

In addition, the invention is not limited to the above-described embodiment, and may be modified to various forms of the embodiment, if necessary.

For example, in the embodiment, the supporting-side sidewall portion is formed in the same manner as the sheet supplying-side bobbin and the sheet winding-side bobbin, but the supporting-side sidewall portion may be formed in the same manner as only one of the bobbins, for example, the sheet winding-side bobbin, if necessary. The spring member is not limited to the spring member of the coil shape and may be formed in a plate shape. In addition, the spring member may not be formed. However, when the spring member is not formed, the bobbins may not be biased toward the driving-side sidewall portion with the use of the spring member. Thus, it is preferable to form the spring member. The central wall portion may not be fixed on a case substrate. For example, the locking portion formed on the base of the plate-shaped member may be fitted into the guiding groove facing two slide rails formed on the case substrate and provided to move the slide and the other end of the spring member may be locked to the outer wall surface such that the bobbins are biased toward the driving-side sidewall portion by the elasticity restoring force of the spring member.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

What is claimed is:

1. An ink sheet cartridge in which an ink sheet unit includes a first bobbin on which a longitudinal ink sheet is wound frame one end thereof and a second bobbin on which the ink sheet is wound from the other end thereof, which are detachably received in a cartridge case, wherein the cartridge case comprises:
a case body having an opening portion formed at the center thereof so as to expose the ink sheet used for a printing operation of a printer;
a driving-side sidewall portion disposed vertically on one side of the case body so as to rotatably support driving-side shaft portions formed on ends of the first bobbin and the second bobbin; and
a supporting-side sidewall portion disposed on the other side of the case body so as to rotatably support supporting-side shaft portions formed on the other ends of the first bobbin and the second bobbin.

2. The ink sheet cartridge according to claim 1, wherein the supporting-side sidewall portion includes an outer wall portion forming an outer wall of the cartridge case, an inner wall portion disposed vertically in parallel to the outer wall portion with a predetermined gap therebetween and having a bearing portion so as to support pivotally one end of the first bobbin and/or the second bobbin, and a central wall portion disposed vertically in the gap between the outer wall portion and the inner wall portion, abutting one end of the first bobbin and/or the second bobbin on an inner wall surface, and allowing the first bobbin and/or the second bobbin to be biased toward the driving-side sidewall portion.

3. The ink sheet cartridge according to claim 1, wherein the central wall portion is a cantilever-shaped plate member of which a base portion is fixed to the cartridge case.

4. The ink sheet cartridge according to claim 1, wherein a spring member is formed on the driving-side sidewall portion so as to bias the first bobbin and/or the second bobbin toward the driving-side sidewall portion, a locking portion is formed on the inner wall surface of the outer wall portion so as to lock one end of the spring member, a locking portion is formed on the outer wall surface of the central wall portion so as to lock the other end of the spring member, and a protrusion is formed on the inner wall surface of the central wall portion so as to abut against one end of the first bobbin and/or the second bobbin and to restrict a position of the first bobbin and/or the second bobbin to the inside of the bearing portion.

5. The ink sheet cartridge according to claim 1, wherein a protrusion extending in a space portion right above the spring member is provided.
